(19) United States
(12) Patent Application Publication
(10) Pub. No.: US 2022/0166111 A1
(43) Pub. Date: May 26, 2022

(54) BATTERY MODULE

(71) Applicant: TOYOTA JIDOSHA KABUSHIKI KAISHA, Toyota-shi Aichi-ken (JP)

(72) Inventors: Takuya Toyoda, Toyota-shi Aichi-ken (JP); Masaki Shimada, Kariya-shi Aichi-ken (JP); Shuta Ito, Toyota-shi Aichi-ken (JP); Yusuke Kuruma, Toyota-shi Aichi-ken (JP)

(73) Assignee: TOYOTA JIDOSHA KABUSHIKI KAISHA, Toyota-shi Aichi-ken (JP)

(21) Appl. No.: 17/508,281

(22) Filed: Oct. 22, 2021

(30) Foreign Application Priority Data
Nov. 25, 2020 (JP) 2020-195031

(51) Int. Cl. H01M 50/507; H01M 50/503; H01M 50/543; H01M 50/569; H01M 50/209

(52) U.S. Cl. CPC H01M 50/507; H01M 50/503; H01M 2220/20; H01M 50/569; H01M 50/209; H01M 50/543

(57) ABSTRACT

A battery module includes: a plurality of secondary batteries arranged side by side in one direction; a bus bar via which secondary batteries adjacent to each other in the one direction from among the secondary batteries are electrically connected to each other; and a voltage detecting terminal connected to the bus bar. Each of the secondary batteries includes a pair of external terminals. The bus bar includes connecting portions connected to corresponding external terminals, and a protrusion portion protruding upward from the connecting portions. The voltage detection terminal is connected to the protrusion portion.

### CROSS-REFERENCE TO RELATED APPLICATION

This application claims priority to Japanese Patent Application No. 2020-195031 filed on Nov. 25, 2020, incorporated herein by reference in its entirety.

### BACKGROUND

### 1. Technical Field

This disclosure relates to a battery module.

### 2. Description of Related Art

For example, Japanese Unexamined Patent Application Publication No. 2019-207824 (JP 2019-207824 A) describes a power storage module including a plurality of storage elements, a bus bar via which electrode terminals of storage elements adjacent to each other are electrically connected to each other, and a voltage detection terminal connected to the bus bar. The bus bar includes a first region formed flat, a second region formed flat, and a bending portion formed between the first region and the second region. The bending portion bends upward (in a direction distanced from the electrode terminals). The sectional shape of the bending portion has a U-shape opened downward.

### SUMMARY

The battery module as described in JP 2019-207824 A has the following concern. That is, in a case where the bus bar and the voltage detection terminal are made of different metals, electrical pitting might be caused due to moisture of dew concentration being attached to a boundary portion between the bus bar and the voltage detection terminal.

An object of this disclosure is to provide a battery module that can restrain electrical pitting from being caused in a boundary portion between a bus bar and a voltage detection terminal.

A battery module according to one aspect of this disclosure includes a plurality of secondary batteries, a bus bar, and a voltage detecting terminal. The secondary batteries are arranged side by side in one direction. Secondary batteries adjacent to each other in the one direction from among the secondary batteries are electrically connected to each other via the bus bar. The voltage detecting terminal is made of metal different from metal constituting the bus bar and is connected to the bus bar. Each of the secondary batteries includes a pair of external terminals. The bus bar includes connecting portions connected to corresponding external terminals, and a protrusion portion protruding upward from the connecting portions. The voltage detection terminal is connected to the protrusion portion.

This disclosure can provide a battery module that can restrain electrical pitting from being caused in a boundary portion between a bus bar and a voltage detection terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically illustrating the vicinity of a bus bar of a battery module according to one embodiment of this disclosure; and

FIG. 2 is a plan view illustrating a relationship between the bus bar and a resin cover.

### DETAILED DESCRIPTION OF EMBODIMENTS

An embodiment of this disclosure will be described with reference to the drawings. Note that, in the drawings to be referred to in the following description, the same reference sign is assigned to the same or equivalent member.

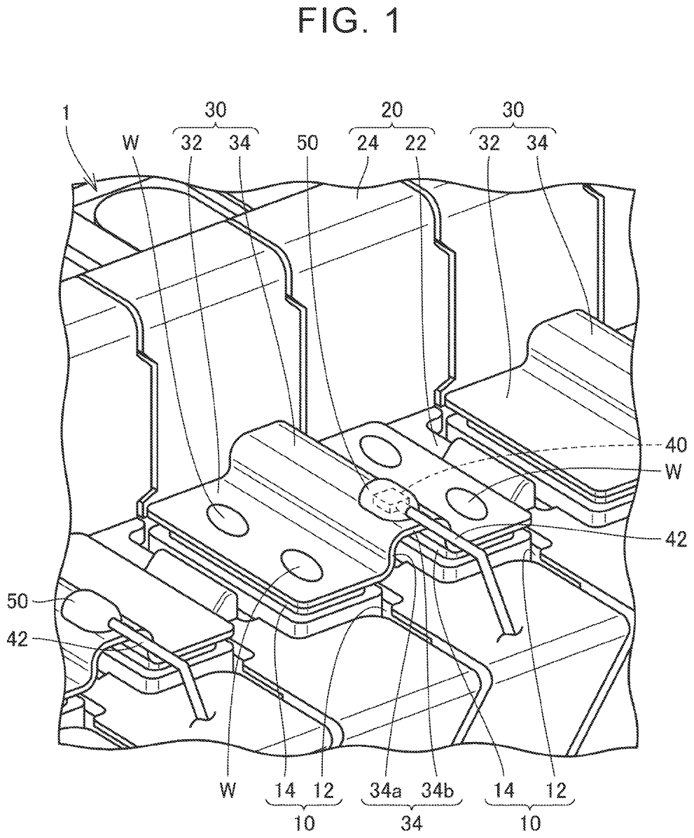

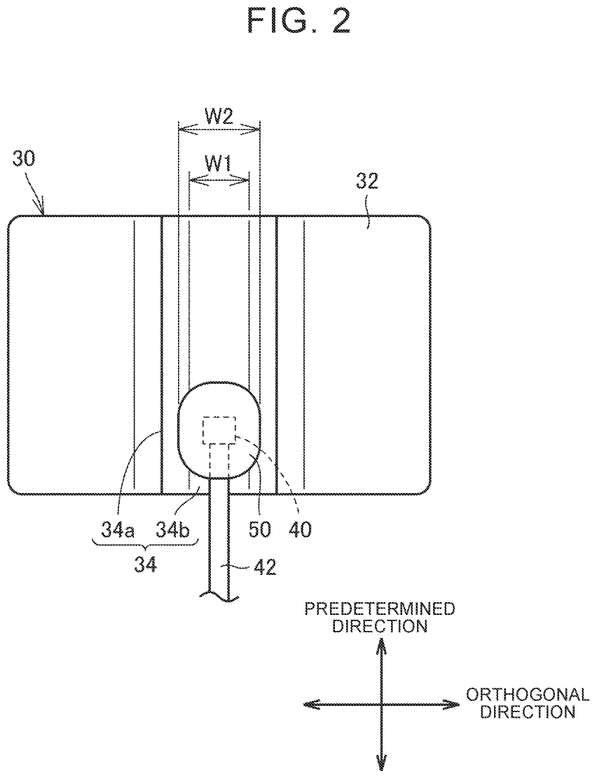

FIG. 1 is a perspective view schematically illustrating the vicinity of a bus bar of a battery module according to one embodiment of this disclosure. FIG. 2 is a plan view illustrating a relationship between the bus bar and a resin cover. The battery module 1 is provided in a vehicle, for example

As illustrated in FIGS. 1 and 2, the battery module 1 includes a plurality of secondary batteries 10, a plurality of resin frames 20, a plurality of bus bars 30, a voltage detection terminal 40, and a resin cover 50.

The secondary batteries 10 are arranged side by side in one direction. The secondary batteries 10 may be lithium-ion batteries, for example. Each of the secondary battery 10 includes a case 12 and a pair of external terminals 14.

The case 12 is formed in a rectangular shape. A relief valve (not illustrated) is provided in a central part on a top face of the case 12.

The external terminals 14 project upward from the top face of the case 12. One of the external terminals 14 is a positive terminal, and the other one of them is a negative terminal. The positive terminal is provided on a first side from the relief valve in a width direction (a direction perpendicular to the one direction and the up-down direction). The negative terminal is provided on a second side from the relief valve in the width direction.

The resin frames 20 are placed so as to be adjacent to the secondary batteries 10 in the one direction. Each of the resin frames 20 includes a partition portion 22 and a duct element 24.

The partition portion 22 is made of an insulation material (resin). The partition portion 22 separates, from each other, the secondary batteries 10 adjacent to each other in the one direction.

As illustrated in FIG. 1, the duct element 24 is connected to an upper part of the partition portion 22. The duct element 24 has a shape covering the relief valve of the secondary battery 10. The duct element 24 is connected to its adjacent duct element 24 in the one direction. The duct elements 24 constitute a smoke discharge duct by being connected to each other. The smoke discharge duct is provided on the secondary batteries 10 and constitutes a smoke discharge passage through which gas caused from the relief valves of the secondary batteries 10 is discharged.

The bus bar 30 electrically connects the external terminals 14 adjacent to each other in the one direction. In the present embodiment, the bus bar 30 electrically connects the positive terminal of a first secondary battery 10 to a negative terminal of a second secondary battery 10 adjacent to the first secondary battery 10. That is, the secondary batteries 10 are connected to each other in series via the bus bars 30. The bus bars 30 are made of aluminum, for example.

The bus bar 30 includes a pair of connecting portions 32 and a protrusion portion 34.

The connecting portion 32 is a part connected to the external terminal 14. The connecting portion 32 is formed flat. The connecting portion 32 is welded to the external terminal 14 at welded portions W (see FIG. 1). The connecting portion 32 has an outer shape larger than that of the external terminal 14.

The protrusion portion 34 protrudes upward from the connecting portions 32. The protrusion portion 34 connects the connecting portions 32 to each other. The protrusion portion 34 includes a pair of standing portions 34a and a flat portion 34b.

The standing portion 34a has a shape standing from the connecting portion 32. The standing portion 34a is formed in a flat-plate shape. A boundary portion between the standing portion 34a and the connecting portion 32 is formed in a curving shape.

The flat portion 34b connects respective upper end parts of the standing portions 34a to each other. The flat portion 34b extends in a predetermined direction and is formed flat. In the present embodiment, the predetermined direction is set to a direction (the up-down direction in FIG. 2) perpendicular to both the one direction and the up-down direction. A boundary portion between the flat portion 34b and the standing portion 34a is formed in a curving shape.

The voltage detection terminal 40 detects a potential of the secondary battery 10. The voltage detection terminal 40 is made of metal different from metal constituting the bus bar 30. The voltage detection terminal 40 is made of copper, for example. The voltage detection terminal 40 is connected to the bus bar 30. The voltage detection terminal 40 is connected to the protrusion portion 34. More specifically, the voltage detection terminal 40 is connected to the flat portion 34b of the protrusion portion 34. The voltage detection terminal 40 is connected to the bus bar 30 by solid-phase welding (ultrasonic bonding or the like). A voltage detection line 42 is connected to the voltage detection terminal 40. The voltage detection line 42 is connected to an ECU (not illustrated).

The resin cover 50 is made of resin and covers the voltage detection terminal 40. The resin cover 50 is formed by resin potting. As illustrated in FIG. 2, a width W2 of the resin cover 50 in an orthogonal direction (a direction parallel to the one direction in the present embodiment) that is perpendicular to the predetermined direction is larger than a width W1 of the flat portion 34b in the orthogonal direction.

As described above, in the battery module 1 of the present embodiment, the voltage detection terminal 40 is connected to the protrusion portion 34 of the bus bar 30. Accordingly, it is possible to restrain moisture from being attached to or accumulated on the boundary portion between the bus bar 30 and the voltage detection terminal 40 due to dew condensation or the like. Accordingly it is possible to restrain occurrence of electrical pitting in the boundary portion.

A person skilled in the art will understand that the embodiment described above is a concrete example of the following aspects.

The battery module in above embodiment includes: a plurality of secondary batteries arranged side by side in one direction; a bus bar via which secondary batteries adjacent to each other in the one direction from among the secondary batteries are electrically connected to each other; and a voltage detection terminal made of metal different from metal constituting the bus bar and connected to the bus bar. Each of the secondary batteries includes a pair of external terminals. The bus bar includes connecting portions connected to corresponding external terminals, and a protrusion portion protruding upward from the connecting portions. The voltage detection terminal is connected to the protrusion portion.

In the battery module, since the voltage detection terminal is connected to the protrusion portion of the bus bar, it is possible to restrain moisture from being attached to or accumulated on a boundary portion between the bus bar and the voltage detection terminal due to dew condensation or the like. Accordingly, it is possible to restrain occurrence of electrical pitting in the boundary portion.

Further, the battery module may further include a resin cover made of resin and configured to cover the voltage detection terminal.

With this configuration, it is possible to improve moisture resistance of the boundary portion between the bus bar and the voltage detection terminal.

Further, the protrusion portion may include a flat portion extending in a predetermined direction and formed flat. The voltage detection terminal may be connected to the flat portion. A width of the resin cover in an orthogonal direction perpendicular to the predetermined direction may be larger than a width of the flat portion in the orthogonal direction.

With such a configuration, it is possible to restrain accumulation of moisture on a boundary portion between the bus bar and the resin cover. Accordingly, it is possible to further improve the moisture resistance of the boundary portion between the bus bar and the voltage detection terminal.

Note that it should be considered that the embodiment disclosed herein is just an example in all respects and is not limitative. The scope of the present disclosure is shown by Claims, not by the descriptions of the above embodiment, and further includes every modification made within the meaning and scope equivalent to Claims.

What is claimed is:

1. A battery module comprising:
a plurality of secondary batteries arranged side by side in one direction;
a bus bar via which secondary batteries adjacent to each other in the one direction from among the secondary batteries are electrically connected to each other; and
a voltage detecting terminal made of metal different from metal constituting the bus bar and connected to the bus bar, wherein:
each of the secondary batteries includes a pair of external terminals;
the bus bar includes
connecting portions connected to corresponding external terminals, and
a protrusion portion protruding upward from the connecting portions; and
the voltage detection terminal is connected to the protrusion portion.

2. The battery module according to claim 1, further comprising a resin cover made of resin and configured to cover the voltage detection terminal.

3. The battery module according to claim 2, wherein:
the protrusion portion includes a flat portion extending in a predetermined direction and formed flat;
the voltage detection terminal is connected to the flat portion; and
a width of the resin cover in an orthogonal direction perpendicular to the predetermined direction is larger than a width of the flat portion in the orthogonal direction.
